(19) United States
(12) Patent Application Publication
(10) Pub. No.: US 2005/0072921 A1
(43) Pub. Date: Apr. 7, 2005

(54) Device for improving the visibility conditions in a motor vehicle

(76) Inventors: Joerg Moisel, Neu-Ulm (DE); Michael Holz, Senden (DE)

Correspondence Address: PENDORF & CUTLIFF, 5111 MEMORIAL HIGHWAY, TAMPA, FL, 33634-7356, US

(21) Appl. No.: 10/957,793

(22) Filed: Oct. 4, 2004

(30) Foreign Application Priority Data
Oct. 2, 2003 (DE) 103 46507.3-51

(51) Int. Cl. G02F 1/01

(52) U.S. Cl. 250/330

(57) ABSTRACT

The invention relates to a device for improving the visibility conditions in a motor vehicle, having a radiation source for infrared radiation for irradiating the surroundings of the vehicle, having an infrared-sensitive camera for taking images of at least part of the irradiated surroundings, having a display unit for displaying collected image data and having a control unit for controlling the device. Here, the control unit is embodied in such a way that the display is switched off or on as a function of the collected image data. The camera is preferably selected such that it is also sensitive in the range of visible light. The display is preferably switched off or on as a function of the brightness values and/or the contrast values of the collected image data. It has also proven effective to provide an image evaluation unit which is connected to the camera and to the control unit and which evaluates the collected image data with respect to the state of the surroundings, in particular with respect to the profile of the underlying surface, the state of the underlying surface, the state of the weather or the traffic volume, in such a way that the display is switched off or on as a function thereof. This device ensures that the vehicle with the device operates very safely for the user.

### BACKGROUND OF THE INVENTION

1. Field of Invention

The invention relates to a device for improving the visibility in a motor vehicle.

2. Related Art of the Invention

DE 40 32 927 C2 discloses a device for improving the visibility in a motor vehicle having a radiation source for infrared radiation for irradiating the surroundings of the vehicle, and having an infrared-sensitive camera which takes images of the irradiated field of vision of the driver and makes available the collected image data to the driver by means of a display device which is embodied as a head-up display and in which the image data is visually superimposed as a virtual image on the external landscape. By means of this device, the driver can see considerably better at night or in bad weather conditions, in particular when he is dazzled by oncoming vehicles. As a result of the use of infrared radiation, the driver is, in contrast, not dazzled by the oncoming traffic. Such devices as this are also called night vision systems.

By virtue of the improved visibility, the driver of the vehicle may be induced to look exclusively at the display and not to observe the surroundings any more, which can lead to misinterpretations. In particular there is the risk of the field of vision being overestimated and of driving too quickly owing to the supposedly better visibility.

### SUMMARY OF THE INVENTION

The invention is based on the object of specifying a device for improving the visibility conditions in a motor vehicle which reduces these disadvantages and as a result improves traffic safety.

This object is achieved by means of a device for improving the visibility conditions in a motor vehicle having the features of claim 1.

Advantageous further developments of the device are the subject matter of the subclaims.

The device according to the invention for improving the visibility conditions in a motor vehicle is provided with a radiation source for infrared radiation for irradiating the surroundings of the vehicle, with an infrared-sensitive camera for taking images of at least part of the irradiated surroundings, with a display unit for displaying collected image data and with a control unit for controlling the device. Here, the control unit is embodied in such a way that the display is switched on or off as a function of the collected image data. The collected image data is evaluated here with respect to its properties, for example the brightness values or contrast values, by means of an image data evaluation unit and the display is then switched on or off as a function of these properties by means of the control unit. The switching on or off is carried out here, for example, by means of a reference table in which a measure for the respective properties is related to a switching-on or -off process. There is also an arithmetic relationship, for example by means of a direct conversion rule which calculates a property value, for example on the basis of the average brightness or the average contrast, which value controls the switching on or off when one or more predefined switching values are exceeded. This embodiment of the device makes it possible to ensure very up-to-date behavior of the device or control behavior which is tailored to the current image data and thus to the current situation of the surroundings. This ensures that the appropriate switching-on and -off times are selected as a function of the respective situation of the surroundings and thus the respective visibility conditions, and the vehicle driver is thus reliably induced not to rely too much on the displaying of the image data on the display. As a result, it is possible to prevent the driver from considering only the image data displayed on the display and to induce him at least to additionally take into account the immediate surroundings. This leads to a marked improvement in the driving behavior and thus in the safety of the vehicle driver, of the vehicle and also of the traffic as a whole.

It is possible, since the mode of operation of the device forces the driver to stop looking at the representation of the surroundings on the display, to reduce the risk of overestimating the visibility conditions and thus the risk of driving too fast since the vehicle driver then cannot rely only on the improved visibility which is provided by the device according to the invention. Overall, these aspects lead to an improvement in the safety of the vehicle driver or the driver and thus also of the traffic as a whole and the persons involved in it.

The camera is preferably selected in such a way that it is sensitive to infrared radiation, and that it is also sensitive in particular in the range of visible light or in parts thereof. The control unit is embodied here in such a way that the display is switched off or on in the range of infrared radiation as a function of the brightness values of the image data which is collected by the camera in the range of infrared radiation or else in the range of visible light. Very reliable control can be ensured by means of the brightness values on the basis of infrared radiation and other light ranges.

It has also proven effective to evaluate the collected image data with respect to its display content by means of an image data evaluation unit in that a sensed traffic scene is classified by means of a classifier. If, for example, the classifier evaluates the profile of the underlying surface at a bendy section of road or at a freeway or evaluates a road sign at the edge of the road as a velocity-related road sign, the switching off and on is triggered in accordance with this evaluation. For example, in the case of an extremely bendy section of road the device is switched off whereas in the case of a section of road which has fewer bends the device is switched on or is not switched off. In particular, in the case of a straight profile or in the case of a freeway, the device is switched off later. The device is also switched off earlier as the maximum velocity increases, for example.

It has proven particularly effective to use the image evaluation unit to sense not only the profile of the underlying surface, and to bring about the switching on or off of the display as a function thereof, but rather it has also proven effective additionally or alternatively to evaluate the state of the underlying surface, the state of the weather, in particular rain, fog, snow or ice, or else the traffic volume, in particular with respect to the presence of oncoming traffic, and to switch the display off or on in a selective fashion as a function of these states of the surroundings which are sensed and evaluated by means of the image evaluation unit.

If a very poor state of the underlying surface is determined by means of the image evaluation unit, the display is switched off or it is switched off earlier, whereas in the case of a better state of the underlying surface, i.e. for example when there are fewer potholes or when the road is dry, the display is switched on, or remains switched on for longer and is not switched off. As a result it becomes clear that when the value of a state of the underlying surface drops below a limiting value, the display is switched off in a selective fashion under the control of the control unit. The same applies to the state of the weather which can be evaluated in particular with respect to the presence or the severity of the rain or other precipitations, in particular with respect to the field of vision, using the image evaluation unit, and the display can thus be switched off or on in a selective fashion when the value exceeds or drops below one or more limiting values.

In this context, the switching off is preferably selected in the case of a relatively poor state of the surroundings and the switching on is selected in the case of a better state of the surroundings, as a result of which unpleasant switching on and off of the representation on the display can be prevented by a type of hysteresis in the switching process. In addition to the state of the weather, the traffic volume can also be evaluated by means of the image evaluation unit and used as the basis for the switching behavior of the control unit. These various influencing variables, which are all relevant for considering the state of the surroundings in itself or in a common consideration of a plurality of influencing variables, make it possible to provide a very reliable control of the device which terminates the reproduction of the image data on the display when a poor state of the surroundings is present, and starts the reproduction of the display when a sufficiently good state of the surroundings is reached. Controlling the device as a function of the situation or the state of the surroundings in this way provides a very reliable and safe device for improving the visibility conditions, which device always reliably switches the device off and on again as a function of the respective state of the surroundings and thus makes the improved visibility available to the vehicle driver by means of the device or, even in the case of a poor state of the surroundings, induces the driver to concentrate on considering the surroundings directly and to adapt his driving behavior to this direct consideration or to make this the basis for his driving decisions.

According to another preferred embodiment of the invention, in addition to the on and off switches for the device, an additional switch for switching on the display and/or the camera of the device is provided. This additional switch permits active, conscious switching on of the representation of images on the display after the display has been switched off. This ensures that the vehicle driver can completely activate the device as required by activating the additional switch and can thus obtain the advantage of the improved visibility. It has proven particularly effective here to implement the additional switch in the region of the steering wheel, in particular in the form of a headlamp flasher switch or a rocker on the steering wheel. By arranging the additional switch in the region of the steering wheel it is possible to actuate the switch without the driver having to take one or both hands completely off the steering wheel. This leads to very safe handling of the device and thus to an increase in road safety. It has proven particularly effective to use the headlamp flasher switch as an additional switch for the device, ensuring that by actuating the headlamp flasher switch not only the headlamp flasher but also the display or the camera is actuated again. This leads to a situation in which images of at least part of the surroundings of the vehicle which are irradiated by the infrared radiation source are taken by the camera and the collected image data can be displayed on the display.

It has proven particularly advantageous to make the switching off of the display, that is to say the termination of the representation of the images, sudden, that is to say abrupt. This has the advantage that a control of the device which is simple and not very susceptible to faults is sufficient to bring about this positive effect according to the invention for increasing the road safety.

Furthermore, according to another embodiment of the invention it has proven effective to make the switching-off process gradual so that the reproduction of images does not change abruptly but rather gradually, over a certain time period, from the complete representation of image data to the switched-off state without representation of data. In this context, this gradual switching off can be brought about, for example, by restricting the brightness values or contrast values of the representation of images or of the display in such a way that an increasingly low brightness range or contrast range is continuously made available. This reduction of the brightness range or contrast range is continued until these ranges have dropped to zero and thus the display is switched off. Alternatively, it has also proven effective to dissociate the image data by means of artificial noise and to make the dissociation become stronger and stronger, which is brought about by increasing the proportion of noise until the image data can virtually no longer be perceived. This state corresponds to the switched-off display since this display is no longer suitable for displaying the image data to be displayed which relates to the sensed surroundings which are irradiated by infrared light. This switching-off process is preferably implemented as a linearly extending gradual transition, which is made possible by means of a control which is not too complicated. Alternatively, nonlinear processes are also conceivable. This embodiment of the device according to the invention with a gradual switching-off process ensures that the user receives information about the imminent final termination of the representation of images before the final switching off of the representation of images on the display, and is thus not unpleasantly surprised. This has a positive effect on the reduction of the risk of accidents.

According to one preferred embodiment of the device according to the invention, said device is connected to a second optical sensor which constitutes, in particular, a rain-light sensor or an optical anti-dazzle sensor. This additional optical sensor, which is typically already present in order to carry out another function in the vehicle, supplies an electrical control signal to the control unit, which unit switches the display, and if appropriate also the camera, off and on as a function of the collected sensor data. The additional optical sensor is suitable for collecting reliable information about the state of the surroundings, for example relating to the brightness which is present or the state of the weather or other states of the surroundings, and for providing a corresponding control signal to the control unit as a function of this collected information about the surroundings. For example, the sensor, in the form of a rain-light sensor which detects the presence of rain and/or light, in particular on an optical basis, can inform the control unit that rain or other adverse weather conditions in the form of precipitations are currently present, which conditions lead to a situation in which the display is to be switched off. Whereas, in the case of precipitations which are not so severe or in the case of no precipitations, the display can be switched on again in a selective fashion or cannot be switched off. Correspondingly, the camera is switched on or off in order to reduce markedly the energy consumption of the device as a whole. This leads to very safe handling and control of the device.

Using an optical antidazzle sensor, which is usually continuously in operation, in precisely the same way as the, in particular, optical rain sensor or the light sensor, permits conclusions to be drawn about the state of the surroundings, for example the traffic volume, as a function of which the control unit switches the display or the camera on or off in a selective fashion. By means of the integrated use of a further, in particular optical sensor, which is separate from the camera which is costly in terms of energy and is designed and operated as a function of the latter, it is possible to permit very safe operation, in particular taking into account the energy balance, which provides the possibility of making available the necessary improved visibility to the driver as a function of the situation, without encouraging him to fail to apply the necessary care with respect to driving the vehicle without directly considering the surroundings. The additional, in particular optical, sensor is embodied here as a sensor which is economical in terms of its energy consumption and which is preferably formed by an, in particular optical, sensor—which is already present in the vehicle—of an assistant system, for example a rain sensor or daylight sensor or darkness sensor or antidazzle sensor. As a result it is possible, on the one hand, to keep the energy consumption low and, on the other hand, to limit the costs of such a device.

In addition to the possibility of providing various thresholds for the switching off or on, it has also proven effective to perform the switching off of the device under the control of the control unit with a delay by a time period to. This delayed switching off, which is preferably in the range of a few minutes, makes it possible to decouple the switching off markedly from the switching on, in the manner of a hysteresis for the switching on or off, and as a result to prevent unpleasant or undesired repeated, fast switching on or off. As a result it is possible to make the device significantly more pleasant and less surprising and thus significantly safer in its switching behavior, i.e. in particular with respect to the switching off and on of the display or of the camera for the user, which has a positive effect on the road safety of the vehicle and also of the other road users and thus of the road safety as a whole.

It has also proven particularly effective to signal the switching off to the vehicle driver before the switching off, which is delayed by the time period to, is carried out. This signaling is carried out, for example, by means of a visual representation on the display, alternatively or additionally by means of haptic signaling, for example by vibrating the steering wheel or by means of an audible signal, for example by the sounding of a short tone. This advance information before the switching off is carried out ensures that the driver is prewarned to a particular degree before the switching off is carried out. This leads to an improvement in road safety. Audible warning signals have proven particularly effective since they can also be perceived without visual contact with the display, for example during the direct consideration of the surroundings of the vehicle, and can thus be perceived by the vehicle driver at regular intervals without interruptions or with only short interruptions in such a way that he is not surprised by the switching off of the display or the representation of images on the display.

According to one particularly preferred embodiment of the device, the control unit is embodied in such a way that the current vehicle velocity can be fed to it and it controls the switching off in such a way that the display or the camera takes place when the vehicle velocity V exceeds a predefined maximum velocity. In this case, it is ensured that the vehicle driver cannot rely on the subjective impression of a particularly good, overestimated visibility and correspondingly makes an inappropriately high selection of his vehicle velocity V in accordance with his misinterpreted field of vision. As a result of the velocity-dependent switching off when a maximum velocity Vₘₐₓ is exceeded, it is ensured that the vehicle driver is forced to rely on the direct sensing of the surroundings of the vehicle, i.e. for example to rely on the usual sensing of the surroundings of the vehicle at night or when visibility is poor and not to use the improved visibility by means of the device which can be made available to him via the display. As a result of this switching off he is forced to consider his velocity at regular intervals since the improved visibility is no longer available to him and correspondingly must select his driving velocity in accordance with the actual visibility in the visible range, that is to say without support by infrared radiation, and correspondingly must make a reduced selection. This leads to a situation in which the driver then reduces his driving velocity regularly on the basis of the poorer visibility, which leads to a situation in which the device can be fully activated again when the velocity drops below a corresponding velocity limit and the improved visibility of the surroundings of the vehicle which is acquired by means of the device can be made available to the driver.

### BRIEF DESCRIPTION OF THE DRAWING

The invention will be explained in more detail below with reference to an exemplary implementation of the device according to the invention for improving the visibility conditions in a motor vehicle. The invention is not restricted to this embodiment.

FIG. 1 shows a schematic design of the device according to the invention for improving the visibility conditions in a motor vehicle.

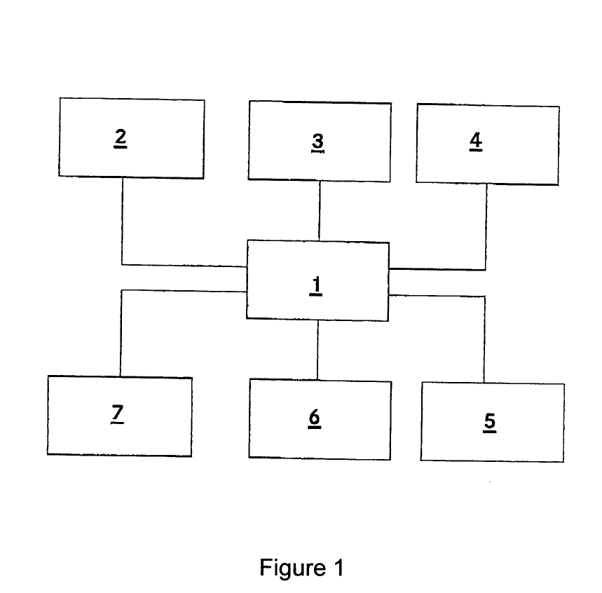

### DETAILED DESCRIPTION OF THE INVENTION

This device exhibits a radiation source 2 for infrared radiation which irradiates infrared radiation with a wavelength of approximately 800 nm. The radiation source 2 is implemented as an infrared laser. This radiation source 2 is arranged in the front region of the vehicle in the region of the headlights and irradiates the region in front of the vehicle. In addition, this device has an infrared-sensitive camera 3 which is arranged in the vehicle and is orientated in such a way that it senses at least part of the surroundings which are irradiated by the infrared radiation source 2, and feeds the collected image data to the display 4 via the control unit 1. By means of the display 4, the image data which is fed to it and collected by the camera 3 is displayed and thus made available to a vehicle driver. The control unit 1 controls the infrared radiation source 2, the camera 3 and the display 4 in this context.

The infrared radiation source 2 radiates infrared radiation here, which is reflected at least partially from the surroundings and collected by the infrared-sensitive camera 3 as reflected radiation and converted into image data. This image data is represented by the display 4 either directly or after a certain degree of image signal processing by means of the image evaluation unit 6. As a result, the image which is represented on the display 4 is an infrared representation of the surroundings of the vehicle. Since the infrared reflective properties and irradiation properties of the surroundings differ from the properties in the visible light range, the image represented will also differ from the direct view of the surroundings by the vehicle driver. By using the device it is possible to use these differences advantageously, which leads to improved visibility in particular at night, but also in bad weather conditions such as in the rain or in fog.

The control unit 1 controls the display 4 here as a function of the collected image data in such a way that the reproduction of the images is switched on or off in a selective fashion. The collected image data is evaluated here with respect to its properties, for example the brightness values or contrast values, by means of an image evaluation unit 6, and the display 4 is then switched on or off as a function of these properties by means of the control unit 1. The switching on or off is carried out here, for example, by means of a reference table in which a measure of the respective properties is related to a switching-on or -off process (switching values for the switching on or off). By means of this embodiment of the device it is possible to ensure a very current behavior of the device or control behavior which is tailored to the current image data and thus to the current situation of the surroundings. This ensures that the suitable switching-on or -off times are selected as a function of the respective situation of the surroundings and thus the respective visibility conditions, and the vehicle driver is thus reliably induced not to rely too much on the representation of the image data on the display 4. As a result, it is possible for the driver to be prevented from considering only the image data displayed on the display 4 and to induce him at least to additionally consider the immediate surroundings. This leads to a marked improvement in the driving behavior and thus in the safety of the vehicle driver, the vehicle and also of the traffic as a whole.

It is not necessary to completely switch off the display 4, for the operational capability of the device according to the invention it is sufficient to merely terminate the representation of images. The switching off of the display 4 requires the vehicle driver to look away from the display 4 and to direct his gaze directly on to the surroundings of the vehicle again. This ensures that he cannot be dazzled by the improved visibility which is provided by the device according to the invention and, owing to the improved visibility, misinterprets his own capabilities, the vehicle or the external circumstances and, for example, drives too quickly or with an inappropriate velocity. Instead, the switching off of the display 4 causes him to turn his attention directly to the surroundings of the vehicle and to adapt his driving behavior in an orderly manner to the visibility conditions which are then available to him and to use again the improved visibility after the device or the representation of images of the display 4 has been switched on again, without automatically being subject to a misinterpretation of the situation. This effect has proven very advantageous and very acceptable. In addition to the switching off of the display 4, the control unit 1 also has the control function of switching off the camera 3 after a time period t_{K} after the display 4 has been switched off, which is, in particular, in the region of one minute or a few minutes. This additional control function ensures very effective operation of the device, in which case, on the one hand, the operational capability of the device is maintained without restriction but, on the other hand, the consumption of energy of the device is markedly reduced. The consumption of energy of such a device is of particular significance in a vehicle since such a vehicle has a large number of electronic components of which a large number operate simultaneously and correspondingly consume a considerable amount of energy which the vehicle, with its autonomous energy supply, can make available only to a limited degree.

Furthermore, the control unit 1 is connected to the headlamp flasher 5 which is arranged as an additional switch in the region of the steering wheel. The actuation of the headlamp flasher switch causes the display 4 or the camera 3 to be actuated again and switched on again under the control of the control unit 1. Then the display 4 or the camera 3 is kept operational until the display 4 and the camera 3 are switched off under the control of the control unit 1 as a function of the image data. As a result of this simple embodiment of an additional switch for switching on the display 4 or the camera 3, a very robust and safe and easy-to-handle device is provided which, on the one hand, makes available improved visibility for the vehicle driver, and on the other hand prevents undesired driving only in accordance with the display, and on the other hand permits actuation without significant difficulties. By using the headlamp flasher switch 5 it is possible for the driver to activate the display 4 or the camera 3 by actuating the headlamp flasher in parallel, without the driver having to release the steering wheel from his secure grip. This leads to very safe handling of the device and thus to an increase in road safety.

The control unit 1 is connected to an image evaluation unit 6 which carries out the termination of the representation of images, and thus the switching off of the display 4, in a gradual fashion. In this context, the collected image data is artificially degraded during the gradual switching off by adding noise components until only noise is represented on the display 4, and the display 4 can thus be switched off, as it were. As the noise increases, the image information which can be sensed, and thus the represented image data, becomes less useful for the vehicle driver, who is accordingly increasingly inclined to view and sense the surroundings of the vehicle directly. This gradual switching off ensures that the driver of the vehicle is forewarned of the imminent final switching off and is therefore not surprised by the final switching off. This has proven very positive for the vehicle driver.

Furthermore, a sensing unit 7 is provided which senses the vehicle velocity V and feeds it to the control unit 1. This control unit 1 compares the current vehicle velocity V, which has been sensed by the sensing unit 7, with a predefined maximum velocity Vₘₐₓ. If the current vehicle velocity V exceeds the maximum velocity Vₘₐₓ, the control unit 1 will switch off the display 4 in a corresponding way to the sequence of the time period t. In addition, the camera 3 is also switched off. When the velocity drops below the maximum velocity, the switched-off components are then activated again so that the image data which is collected by the camera 3 can be made available to the user again on the display 4.

The described device thus exhibits switching off of individual components 3, 4 as a function of the velocity V at which the vehicle is traveling or as a function of the operating time of the display 4 or of the camera 3. This embodiment of the device makes it possible to limit incorrect preconceptions of the vehicle driver with respect to the driving situation and thus to increase the road safety for the vehicle driver, the vehicle and the traffic as a whole.

1. A device for improving the visibility conditions in a motor vehicle, having
a radiation source for infrared radiation for irradiating the surroundings of the vehicle,
an infrared-sensitive camera for taking images of at least part of the irradiated surroundings,
a display unit for displaying collected image data, and
a control unit for controlling the device,
wherein the control unit is embodied in such a way that the display is switched off or on as a function of the collected image data.

2. The device for improving the visibility conditions in a motor vehicle as claimed in claim 1, wherein the camera is sensitive in particular also in the range of visible light, and wherein the control unit is embodied in such a way that the display is switched off or on as a function of the brightness values of the collected image data.

3. The device for improving the visibility conditions in a motor vehicle as claimed in claim 1, wherein the control unit is embodied in such a way that the display is switched off or on as a function of the contrast values of the collected image data.

4. The device for improving the visibility conditions in a motor vehicle as claimed in claim 1, wherein an image evaluation unit is provided which is connected to the camera and to the control unit and which evaluates the collected image data with respect to the state of the surroundings, in particular with respect to the profile of the underlying surface, with respect to the state of the underlying surface, with respect to the state of the weather or with respect to the traffic volume, in particular with respect to the presence of oncoming traffic, in such a way that the display is switched off or on as a function thereof.

5. The device for improving the visibility conditions in a motor vehicle as claimed in claim 1, wherein the control unit is embodied in such a way that the display can be switched off delayed by a time period t₀.

6. The device for improving the visibility conditions in a motor vehicle as claimed in claim 6, wherein the control unit is embodied in such a way that it brings about signaling of the switching off before the delayed switching off is carried out.

7. The device for improving the visibility conditions in a motor vehicle as claimed in claim 1, wherein, in addition to an on/off switch for the device, an additional switch for switching on the display after switching off has been carried out is provided.

8. The device for improving the visibility conditions in a motor vehicle as claimed in claim 7, wherein the additional switch is implemented in the region of the steering wheel, in particular by means of a headlamp flasher switch or a steering wheel rocker.

9. The device for improving the visibility conditions in a motor vehicle as claimed in claim 1, wherein an optical sensor, in particular a rain-light sensor or an optical anti-dazzle sensor is provided and is connected to the control unit in such a way that the display is switched off or on as a function of the collected sensor data.

10. The device for improving the visibility conditions in a motor vehicle as claimed in claim 1, wherein the display is switched off suddenly.

11. The device for improving the visibility conditions in a motor vehicle as claimed in claim 1, wherein the display is switched off gradually.

12. The device for improving the visibility conditions in a motor vehicle as claimed in claim 1, wherein a velocity sensor is provided and is connected to the control unit, and wherein the control unit is embodied in such a way that switching off is carried out when a vehicle velocity v exceeds a predefined maximum velocity vₘₐₓ.
